(19) United States
(12) Patent Application Publication
(10) Pub. No.: US 2024/0160365 A1
(43) Pub. Date: May 16, 2024

(54) INTEGRATED ONLINE AND ON-PREMISES INFORMATION SYSTEM

(71) Applicant: Home Depot Product Authority, LLC, Atlanta, GA (US)

(72) Inventors: RAHUL GANGADHARAN PILLAI, Atlanta, GA (US); Dahesh Patel, Atlanta, GA (US); Nagaraja Reddy Kamireddy, Atlanta, GA (US); Sheetal Pole, Atlanta, GA (US); PRAMOD SALIAN, Atlanta, GA (US)

(21) Appl. No.: 17/985,689

(22) Filed: Nov. 11, 2022

(51) Int. Cl. G06F 3/06

(52) U.S. Cl. CPC G06F 3/0629; G06F 3/0604; G06F 3/0673

(57) ABSTRACT

An integrated electronic information system includes a first information storage system storing information in a first form, a second information storage storing information in a second form that is different from the first form, and an electronic integration system, in electronic communication with the first information storage system and the second information storage system. The electronic integration system is configured to receive an indication from the first information storage system of data that is newly-added to the first information storage system, receive the data from the first information storage system in the first form, and in response to the indication from the first information storage system, translate the data from the first form to the second form, and transmit the data in the second form to the second information storage system.

### FIELD OF THE DISCLOSURE

The present disclosure generally relates to integration of multiple data storage solutions to create a cohesive data storage system.

### BRIEF DESCRIPTION OF THE DRAWINGS

FIG. 1 is a block diagram illustrating an example system for providing an integrated online and on-premises information system.

FIG. 2 is a flow chart illustrating an example method of providing an integrated online and on-premises electronic information system.

FIG. 3 is a flow chart illustrating an example method of handling new data received from a user by a data storage system.

FIG. 4 is a flow chart illustrating an example method of handling data received from an integration system by a data storage system.

FIG. 5 is a flow chart illustrating an example method of utilizing a machine learning-based quote forecasting model.

FIG. 6 is a block diagram view of a user computing environment.

### DETAILED DESCRIPTION

Enterprise data storage systems may be developed, over time, with different data storage solutions to serve different needs. For example, a first data storage solution may have been implemented for on-premises use by the enterprise (e.g., for access by terminals or other computing devices on the enterprise's premises), and that data storage solution may have been optimized for the on-premises environment. For example, the data storage solution for on-premises access may have a schema designed or optimized for a user interface presented on the on-premises computing devices. For the same enterprise, a second data storage solution may have been implemented for online use (e.g., access via a website, mobile application, etc.), and the second data storage solution may be optimized for that use. The second data storage solution may have a schema designed or optimized for a user interface presented on the website, mobile application, or other online environment. The first and second data storage solutions of this example may be different from each other. First, they may be physically separate and distinct data storage. Second, they may utilize different data schemas, each optimized to a particular use. As a result, data entered for one system may not be accessible through the other system's intended interface, and disparate data may exist among the enterprise's different data storage solutions. A data integration system that ensures data consistency among multiple data storage systems may provide a consistent user experience across interfaces and platforms as well as more efficient and robust data storage.

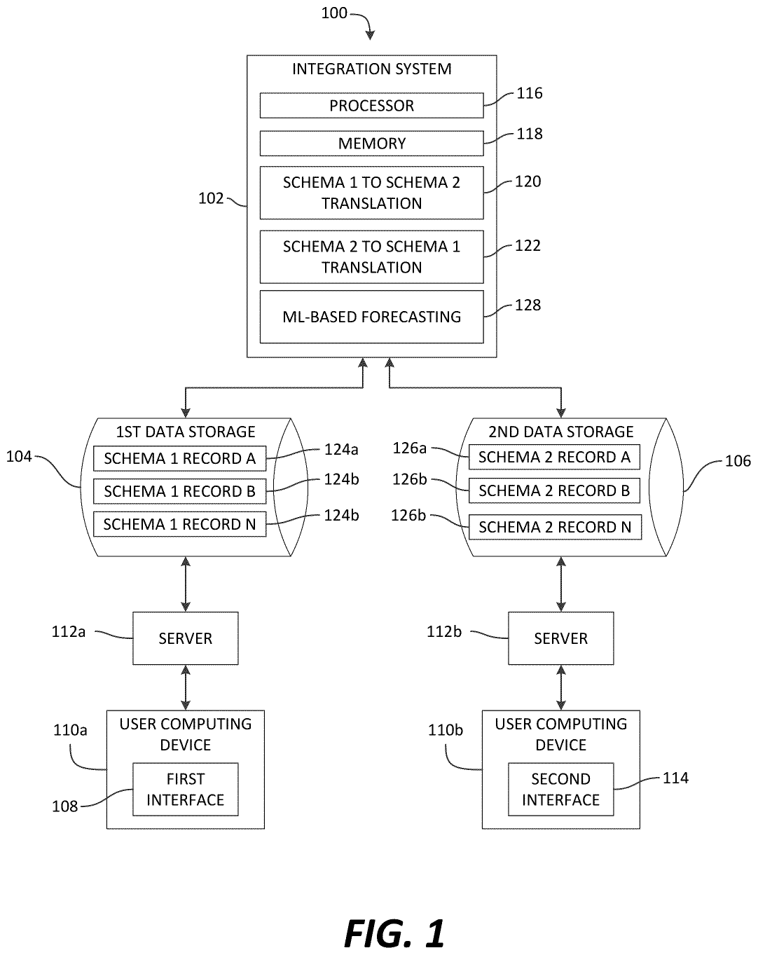

Referring to the drawings, wherein like numerals refer to the same or similar features in the various views, FIG. 1 is a block diagram illustrating an example system 100 for integrated data storage. The system 100 may include a data integration system 102, a first data storage system 104, and a second data storage system 106. The data integration system 102 may be in electronic communication with the first data storage system 104 and the second data storage system 106.

The first data storage system 104 may be or may include one or more databases or other data storage devices. The first data storage system 104 may support the storage of data for, and exchange of data with, a first interface 108 executed on a user computing device 110a through a first communications channel including a first server 112a. The first interface 108 may be, for example, an on-premises interface of an enterprise (e.g., accessible through terminals or other computing devices 110a on the premises of the enterprise). The first data storage system 104 may store data in a first schema (labeled in FIG. 1 as “schema 1”). The first schema may include a plurality of data fields, with each field having a data type (e.g., string, num, etc.), a value, and a definition (e.g., meaning of the data in the field).

The second data storage system 106 may be or may include one or more databases or other data storage devices. The second data storage system 106 may support the storage of data for, and exchange of data with, a second interface 114 executed on a user computing device 110b through a second communications channel including a second server 112b. The second interface 114 may be, for example, a website, mobile application, or similar electronic interface. The second data storage system 106 may store data in a second schema (labeled in FIG. 1 as “schema 2”). The second schema may include a plurality of data fields, with each field having a data type (e.g., string, num, etc.), a value, and a definition (e.g., meaning of the data in the field).

The first schema in which the first data storage system 104 stores data may differ from the second schema in which the second data storage system 106 stores data. For example, the number and/or arrangement of data fields may be different between the first and second schemas. The data types and/or definitions of nominally identical or similar data fields may be different. Additional or alternative differences between the first and second schemas may be present. The differences between the first and second schema may result from each data storage system 104, 106 having been created and/or optimized for a particular interface or environment, with a particular set of anticipated inputs. As a result, data sharing between the first and second data storage systems 104, 106 may be nonexistent or difficult with the native functionality of the data storage systems 104, 106.

The integration system 102 may include a processor 116 and a non-transitory, computer-readable memory 118 containing instructions that, when executed by the processor 116, cause the integration system 102 to perform one or more of the steps, methods, processes, etc. of this disclosure. The integration system 102 may include one or more functional modules embodied as hardware and/or software (e.g., as instructions in the memory 118). For example, the integration system 102 may include a schema 1 to schema 2 translation module 120 (which may be referred to herein as a first translation module 120) and a schema 2 to schema 1 translation module 122 (which may be referred to herein as a second translation module 122), and a machine-learning (ML)-based forecasting module 128.

The first translation module 120 may include or utilize a mapping from the first schema to the second schema. For example, the mapping may include a mapping of fields in the first schema to equivalent fields in the second schema. Additionally or alternatively, the mapping may include a translation of a data type of one or more fields to a different data type of the equivalent field in the second schema. Additionally or alternatively, the mapping may include combining two or more data field values in the first schema to generate a single field value for the second schema. Additionally or alternatively, the mapping may include splitting a data field value, or reproducing a data field value, in the first schema into two or more separate data field values in the second schema.

Similarly, the second translation module 122 may include or utilize a mapping from the second schema to the first schema. For example, the mapping may include a mapping of fields in the second schema to equivalent fields in the first schema. Additionally or alternatively, the mapping may include a translation of a data type of one or more fields to a different data type of the equivalent field in the first schema. Additionally or alternatively, the mapping may include combining two or more data field values in the second schema to generate a single field value for the first schema. Additionally or alternatively, the mapping may include splitting a data field value, or reproducing a data field value, in the second schema into two or more separate data field values in the first schema.

The integration system 102 may be generally configured to receive new data from the data storage systems 104, 106, to translate that new data from the schema of the receiving data storage system 104, 106 to the schema of the other data storage system 104, 106, and to transmit the translated new data to the other data storage system 104, 106 for duplicate storage. As a result, the integration system 102 may facilitate the creation and maintenance of duplicate records in the first and second data storage systems 104, 106.

As an example, the first data storage system 104 may receive new data from a user through the first interface 108. The new data may be the creation of a new record, or may be a modification of an existing record. The first data storage system 104 may automatically transmit the newly-received data, in the form stored in the first data storage system 104 (schema 1), to the integration system 102. The newly-received data may be, for example, Schema 1 Record A (at 124a). The integration system 102 may translate the data from schema 1 to schema 2 using the first translation module 120 and transmit the translated data to the second data storage system 106. The second data storage system may store the translated data (e.g., as Schema 2 Record A at 126a) so that the first and second data storage systems 104, 106 have functionally identical (but not actually identical, as the records are stored in different schemas) storage of Record A. As a result, users can access record A through both first interface 108 and second interface 114.

In another example, the second data storage system 106 may receive new data from a user through the second interface 114. The new data may be the creation of a new record, or may be a modification of an existing record. The second data storage system 106 may automatically transmit the newly-received data, in the form stored in the second data storage system 106 (schema 2), to the integration system 102. The newly-received data may be, for example, Schema 2 Record B (at 126b). The integration system 102 may translate the data from schema 2 to schema 1 using the second translation module 122 and transmit the translated data to the first data storage system 104. The first data storage system 104 may store the translated data (e.g., as Schema 1 Record B at 124b) so that the first and second data storage systems 104, 106 have functionally identical (but not actually identical, as the records are stored in different schemas) storage of Record B. As a result, users can access record B through both first interface 108 and second interface 114.

The functionality and data operations illustrated in the two examples above may be repeated for numerous new data sets (e.g., through Record N, N being a positive number, stored as Schema 1 Record N at 124c and Schema 2 Record N at 126c). Further, the functionality and data operations illustrated inn the two examples above may be utilized to propagate revisions entered at one data storage system (e.g., changes, additions, or deletions) to the other data storage system.

As illustrated in the two examples above, the integration system 102 may, in conjunction with the data storage systems 104, 106, maintain functionally duplicate storage of records so that those records can be accessed and used by users through multiple different interfaces serviced by the different data storage systems 104, 106. Although two data storage systems 104, 106 are illustrated and described in the example system 100, it will be appreciated that the integration system 102 can also function with three, four, or more data storage systems to maintain functionally duplicate records across those numerous data storage systems.

Each data storage system 104, 106 may include redundant storage, in some embodiments. For example, the first data storage system may include two or more redundant data storage devices or set of devices. Additionally or alternatively, each data storage system 104, 106 may include multiple distributed (e.g., geographically distributed) data storage devices or sets of devices.

The system 100 may find particular use in an environment in which a single user may want to access a record through both the first interface 108 and the second interface 114 at various points in time. The user may be able to create a record (e.g., Record A) through the first interface 108, edit the record a first time through the second interface 114 at a later time, and again edit the record through the first interface 108 at a still later time. At each edit time, the user may have access to the entire record even though the edits and record creation were performed through different interfaces supported by different data storage systems.

One particular implementation of the system 100 may be for providing project quotes in a retail environment. In such an implementation, the first interface 108 may be an in-store interface of a retailer used by store associates and/or accessible to users through in-store terminals, and the first data storage system 104 may receive data from, and provide data to support, that in-store interface. The second interface 114 may be the interface of a website or mobile application accessible by users from any internet-enabled computing device, and the second data storage system 106 may receive data from, and provide data to support, the website and/or application. A user may begin a project quote in-store by adding a number of items (e.g., products and/or services) to a project list with an in-store terminal. That project list may then be stored as a record in the first data storage system 104. The integration system 102 may cause the record to be automatically propagated to and stored in the second data storage system 104, and the user may thus add to, delete from, or otherwise revise the project list through the second interface 114 (e.g., after the user has left the store). Such revisions may be propagated to and stored in the first data storage system 102, and the user may then complete the project list and obtain a complete quote in-store, for example. Of course, other sequences of creation, access, and revision to a record are possible with the system 100.

In known systems, the above process would not be possible. The project list created in-store would not be available to the user for access through the website or mobile application due to the separation between the first and second data storage systems 106. As a result, the user would have to attempt to recreate the record through the website or mobile interface, resulting in potentially inconsistent records between the two data storage systems (if the user does not perform a perfect recreation) and needless excess server load (due to the user needing to navigate to pages respective of the items that the user is adding to the project list for a second time). Further, once the user would have completed the project list and quoting process through one of the interfaces, the record in the other data storage system would have unnecessarily persisted for some period of time, resulting in wasted storage resources. Therefore, the approach of this disclosure improves the data storage system by reducing server workload, improving the efficiency of use of data storage resources, and improves the user experience by removing the need for the user to potentially duplicate efforts in multiple interfaces.

The ML-based forecasting module 128 may be configured to forecast quote demand and, based on the forecasted demand, allocate resources and tasks to meet that demand. The forecasted demand may be for both quotes themselves (e.g., the act of receiving quotes and assisting users with those quotes) as well as for materials and supplies requested in those quotes. The forecasting module 128 may include a machine learning model that is trained on one or more of quote data from previous quotes (e.g., quotes making use of the integration system 102, and/or quotes outside of the integration system 102), skill profile data respective of assistants (e.g., in-store associates that may help users with quotes), and supply chain forecasting (e.g., forecasts respective of availability and locations of materials and supplies). Once trained, the model may output one or more of a predicted quote volume (e.g., in terms of quotes entered in-store, by store location, and/or quotes entered through the website or mobile interface). Based on the predicted quote volume, the model may further create a task queue for assisting with predicted quotes and existing quotes, create tickets for assigning labor resources (e.g., in-store associates) to the specific tasks, and assign specific labor resources to specific tasks based on the known skill level of each available labor resource and the complexity of each task.

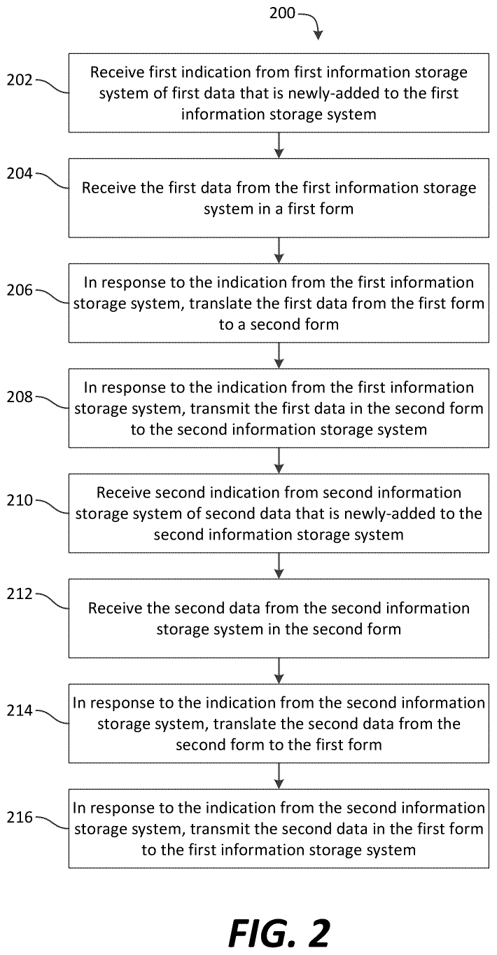

FIG. 2 is a flow chart illustrating an example method 200 of providing an integrated online and on-premises electronic information system. The method 200, or one or more portions of the method 200, may be performed by the integration system 102, in embodiments.

The method 200 may include, at block 202, receiving a first indication from a first information storage system of first data that is newly-added to the first information storage system (e.g., the first data storage system 104 of FIG. 1). The data may have been received by the first information storage system from a user. The first information storage system may be accessible to users, and may have received the newly-added data from a user, through a first communications channel. The first communications channel may include a first user interface, such as an on-premises user interface or a website or mobile application, and a first data transmission path (e.g., a first server). The first information storage may store information in a first form, such as a first schema. The first information storage system may be configured to transmit the indication to the integration system automatically upon receipt of the data, in some embodiments.

The method 200 may further include, at block 204, receiving the first data from the first information storage system in a first form. In some embodiments, the receipt of the data may serve as the indication of block 202. The newly-received data may be received alone, or in conjunction with other data. The first form may be the schema in which the first information storage system stores data.

The method 200 may further include, at block 206, in response to the indication from the first information storage system, translating the first data from the first form to a second form. The second form may be a second schema in which a second information storage system stores data. The second schema may be different from the first schema. The data may be translated at block 206 according to a mapping from the first form to the second form.

The method 200 may further include, at block 208, in response to the indication from the first information storage system, transmitting the first data in the second form to the second information storage system. The second information storage system may be accessible to users through a second communications channel. The second communications channel may include a second user interface, such as an on-premises user interface or a website or mobile application, that is different from the first user interface, and a second data transmission path (e.g., a second server).

The method 200 may further include, at block 210, receiving a second indication from the second information storage system of second data that is newly-added to the second information storage system. The second information storage system may be configured to transmit the second indication to the integration system automatically upon receipt of the second data. The second data may be a revision to the first data (or a record associated with the first data), or may be separate from and independent of the first data.

The method 200 may further include, at block 212, receiving the second data from the second information storage system in the second form. In some embodiments, the receipt of the second data may serve as the indication of block 210. The second data may be received alone, or in conjunction with other data. The second form may be the schema in which the second information storage system stores data.

The method 200 may further include, at block 214, in response to the indication from the second information storage system, translating the second data from the second form to the first form. The data may be translated at block 214 according to a mapping from the second form to the first form.

The method 200 may further include, at block 216, in response to the indication from the second information storage system, transmitting the second data in the first form to the first information storage system.

The method 200 may be implemented to advantageously ensure that records added or revised at different interfaces that are supported by different information storage systems are accessible from both interfaces. Further, the method 200 may be implemented to create and maintain redundant storage of records across multiple information storage systems that store information in different forms.

Although described with respect to two information storage systems, it should be understood that the method 200 may also find use with three, four, or more different information storage systems to translate data from the storage form of one system to the storage form(s) of one or more other systems and to propagate the data to those other systems for functionally redundant storage.

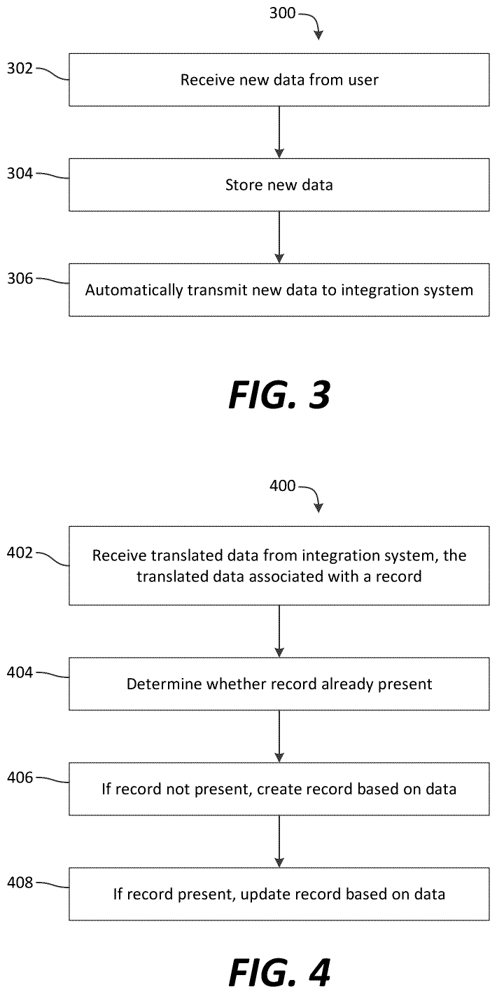

FIG. 3 is a flow chart illustrating an example method 300 of handling new data received from a user by a data storage system. The method 300, or one or more aspects of the method 300, may be performed by a data storage system (e.g., data storage system 104 or data storage system 106).

The method 300 may include, at block 302, receiving new data from a user. The new data may be received through an interface supported by a data storage system performing block 302, in some embodiments. The new data may be received through a communications channel through which a user transmits data to and/or retrieves data from a data storage system performing block 302, in some embodiments.

The method 300 may further include, at block 304, storing the new data. Block 304 may include determining that the new data is associated with a transaction having a stored record in a data storage system performing block 304 and updating the record according to the data, in some embodiments. For example, updating the record may include adding data to the record, revising data in the record, or removing data from the record. In other embodiments, block 304 may include determining that the data is associated with a transaction that does not have a record in a data storage system performing block 304, and creating a record in the data storage system for the transaction, where the record includes the received data.

The method 300 may further include, at block 306, automatically transmitting the new data to an integration system. Block 306 may include, in some embodiments, the data storage system automatically pushing the new data to the integration system. In other embodiments, block 306 may include the data storage system automatically responding to a request for the data from the integration system. In some embodiments, block 306 may include automatically transmitting the new data in response to an existing

FIG. 4 is a flow chart illustrating an example method 400 of handling data received from an integration system by a data storage system. The method 400, or one or more aspects of the method 400, may be performed by a data storage system (e.g., data storage system 104 or data storage system 106).

The method 400 may include, at block 402, receiving translated data from an integration system, where the translated data is associated with a record. The data received at block 402 may have been translated by the integration system from the schema of another data storage system (as described above with respect to blocks 206, 208, 214, and 216).

The method 400 may further include, at block 404, determining whether the record is already present in the data storage system. The method may further include, at block 406, if the record is not present, creating a record based on the data. Block 406 may include creating and storing the record in a schema respective of the data storage system performing block 406. At block 408, the method may further include, if the record is present, updating the record based on the data. Block 408 may include appending data to the record, modifying existing data (e.g., changing the values of one or more data fields already present in the record), or deleting data from the record, for example.

Methods 300, 400 may be performed by data storage system in connection with method 200 being performed by an integration system to create and maintain functionally duplicate storage of records across disparate data storage systems so that those records can be accessed and used by users through multiple different interfaces serviced by the different data storage systems.

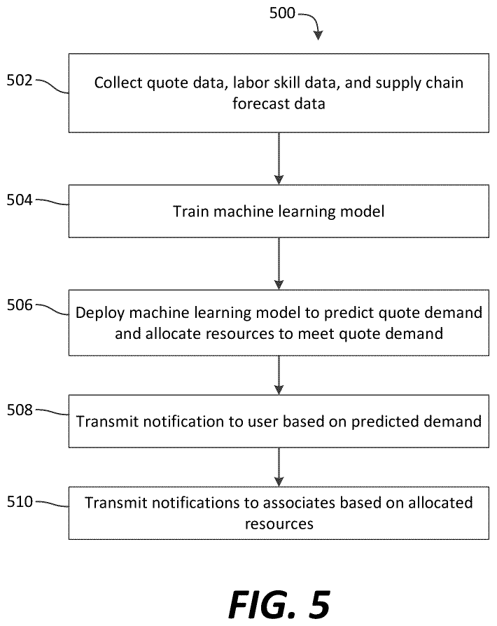

FIG. 5 is a flow chart illustrating an example method 500 of utilizing a machine learning-based quote forecasting model. The method 500, or one or more portions of the method 500, may be performed by the integration system 102, in embodiments.

The method 500 may include, at block 502, collecting quote data, labor skill data, and supply chain data. The quote data may include data respective of historical quotes requested by users (e.g., through user computing devices 110). Collected quote data may be respective of quotes received both on-premises and online, in some embodiments. The quote data may include, for each of a plurality of quotes, the materials and supplies included in the quote, the on-premises location where the quote was input (if any), the location(s) where the materials and supplies of the quote were delivered or picked up, the user associated with the quote, the labor tasks (e.g., by in-store associates) that were performed for the quote, and/or other information associated with the quote. The labor skill data may include particular skills for each of a plurality of labor resources (e.g., in-store associates), including labor resources available or typically available at a store location. The supply chain data may include data respective of availability of materials and supplies at times coincident with the quotes in the quote data, for example, including locations and quantities of such materials and supplies, and whether such materials and supplies were sufficient to satisfy the quotes.

The method 500 may further include, at block 504, training a machine learning model according to the data collected at block 502. The model may be trained to predict quotes, the locations of quotes, the materials and supplies included in those quotes, labor resources and tasks associated with those quotes, and/or other information related to quotes. The model may be trained to make such predictions according to, for example, the current date, quote trends and volumes, and other market conditions. The model may be or may include any kind of predictive machine learning model, including but not limited to one or more neural networks.

The method 500 may further include, at block 506, deploying the trained machine learning model to predict quote demand and allocate resources to meet quote demand. The model may be deployed, for example, so as to continuously predict quote demand given present market conditions. Based on the quote demand predicted by the model, labor resources may be allocated, supplies and materials may be allocated, and/or other actions may be taken.

The method 500 may further include, at block 508, transmitting a notification to user based on predicted demand. For example, block 508 may include transmitting a notification to a user in response to the user beginning a quote, or submitting a partial quote, to inform the user of supply chain conditions relevant to the quote, to recommend one or more additional items to add to the quote, to refer the user to particular labor resources assigned to the user's quote, etc.

The method 500 may further include, at block 510, transmitting notifications to associates based on allocated resources. Block 510 may include, for example, transmitting notifications to assign in-store associates to certain anticipated or actual quote tasks.

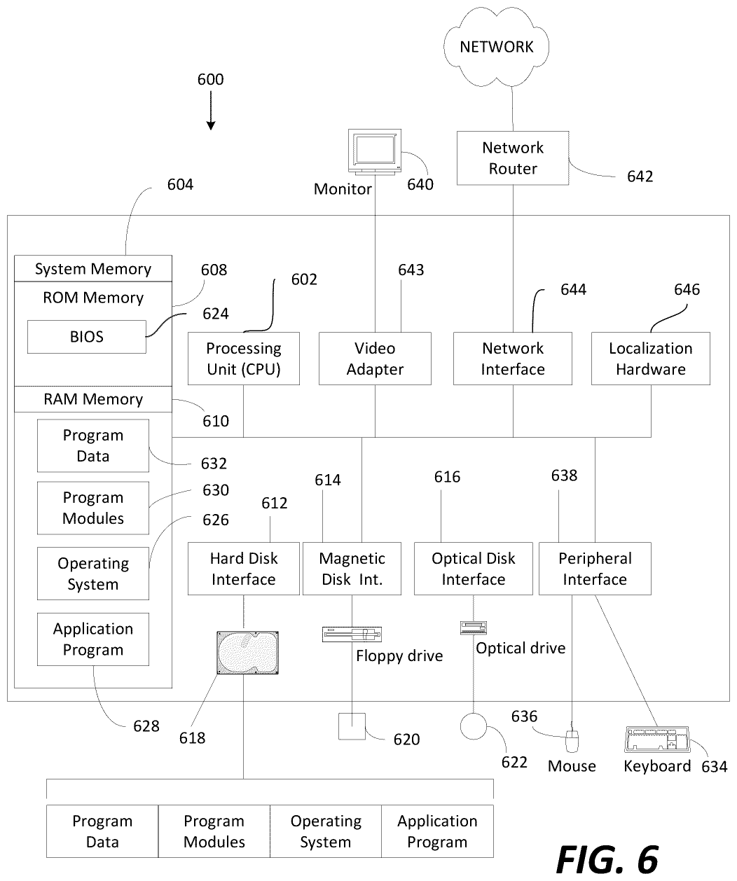

FIG. 6 is a diagrammatic view of an example embodiment of a user computing environment that includes a computing system environment 600, such as a desktop computer, laptop, smartphone, tablet, or any other such device having the ability to execute instructions, such as those stored within a non-transient, computer-readable medium. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 600 typically includes at least one processing unit 602 and at least one memory 604, which may be linked via a bus. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard disk 618, and/or peripheral memory devices may be used to store computer executable instructions comprising an operating system 626, one or more applications programs 628 (which may include the functionality of the integration system 102 and/or of the data storage systems 104, 106 of FIG. 1, for example), other program modules 630, and/or program data 632. Still further, computer-executable instructions may be downloaded to the computing environment 600 as needed, for example, via a network connection.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus via an interface, such as via video adapter 643. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 642, that is responsible for network routing. Communications with the network router 642 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 646 for determining a location of the computing system environment 600. In embodiments, the localization hardware 646 may include, for example only, a GPS antenna, an RFID chip or reader, a WiFi antenna, or other computing hardware that may be used to capture or transmit signals that may be used to determine the location of the computing system environment 600.

The computing environment 600, or portions thereof, may comprise one or more components of the system 100 of FIG. 1, in embodiments.

In a first aspect of the present disclosure, an integrated electronic information system is disclosed. The system includes a first information storage system accessible to users through a first communications channel, the first information storage storing information in a first form. The system further includes a second information storage system accessible to users through a second communications channel, the second information storage storing information in a second form that is different from the first form. The system further includes an electronic integration system, in electronic communication with the first information storage system and the second information storage system. The electronic integration system is configured to receive an indication from the first information storage system of data that is newly-added to the first information storage system, receive the data from the first information storage system in the first form, and in response to the indication from the first information storage system, translate the data from the first form to the second form, and transmit the data in the second form to the second information storage system.

In an embodiment of the first aspect, the first information storage system is configured to transmit the indication to the integration system automatically upon receipt of the data.

In an embodiment of the first aspect, the data is first data respective of a transaction, and the integration system is further configured to receive a second indication from the second information storage system of second data that is newly-added to the second information storage system, the second data respective of the transaction, receive the second data from the second information storage system, and in response to the second indication from the second information storage system, translate the second data from the second form to the first form, and transmit the second data in the first form to the first information storage system.

In an embodiment of the first aspect, the second information storage system is configured to transmit the second indication to the integration system automatically upon receipt of the second data.

In an embodiment of the first aspect, the first communications channel is one of (i) an on-premises user interface or (ii) a website or mobile application, and the second communications channel is the other of (i) or (ii).

In an embodiment of the first aspect, the first form comprises a first schema and the second form comprises a second schema, wherein the first schema is different from the second schema.

In an embodiment of the first aspect, the second information storage system is configured to receive the data in the second form from the integration system, determine that the data is associated with a transaction having a record in the second information storage system, and update the record according to the data.

In an embodiment of the first aspect, the second information storage system is configured to receive the data in the second form from the integration system, determine that the data is associated with a transaction that does not have a record in the second information storage system, and create a record in the second information storage system for the transaction, the record comprising the data.

In a second aspect of the present disclosure, a method is disclosed that includes receiving, by an electronic data storage integration system from a first information storage system, an indication of data that is newly-added to the first information storage system, wherein the first information storage system is user-accessible through a first interface, receiving, by the electronic data storage integration system from the first information storage system, the data in a first schema, translating, by the electronic data storage integration system, the data from the first schema to a second schema, and transmitting, by the electronic data storage integration system, the data in the second schema to a second information storage system, wherein the second information storage system is user-accessible through a second interface.

In an embodiment of the second aspect, the method further includes automatically transmitting, by the first information storage system, the indication to the integration system automatically upon receipt of the data.

In an embodiment of the second aspect, the data is first data respective of a transaction, and the method further includes receiving, by the electronic data storage integration system, a second indication from the second information storage system of second data that is newly-added to the second information storage system, the second data respective of the transaction, receiving, by the electronic data storage integration system, the second data from the second information storage system in the second schema, and by the electronic data storage integration system, in response to the second indication from the second information storage system, translating the second data from the second schema to the first schema, and transmitting the second data in the first schema to the first information storage system.

In an embodiment of the second aspect, the method further includes transmitting, by the second information storage system, the second indication to the integration system automatically upon receipt of the second data.

In an embodiment of the second aspect, the first interface is one of (i) an on-premises user interface or (ii) a website or mobile application, and the second interface is the other of (i) or (ii).

In an embodiment of the second aspect, the method further includes receiving, by the second information storage system, the data in the second schema from the integration system, determining, by the second information storage system, that the data is associated with a transaction having a record in the second information storage system, and updating, by the second information storage system, the record according to the data.

In an embodiment of the second aspect, the method further includes receiving, by the second information storage system, the data in the second schema from the integration system, determining, by the second information storage system, that the data is associated with a transaction that does not have a record in the second information storage system, and creating, by the second information storage system, a record in the second information storage system for the transaction, the record comprising the data.

In a third aspect of the present disclosure, an integrated electronic information system is disclosed. The system includes a first information storage system accessible to users through a first interface, the first information storage storing information in a first schema, a second information storage system accessible to users through a second interface, the second information storage storing information in a second schema, and an electronic integration system, in electronic communication with the first information storage system and the second information storage system. The electronic integration system is configured to automatically translate data added to the first information storage system from the first schema to the second schema and to automatically translate data added to the second information storage system from the second schema to the first schema to create duplicate records in the first and second information storage systems.

In an embodiment of the third aspect, the electronic integration system is further configured to automatically transmit data translated to the second schema to the second information storage system and to automatically transmit data translated to the first schema to the first information storage system.

In an embodiment of the third aspect, the first interface is one of (i) an on-premises user interface or (ii) a website or mobile application, and the second interface is the other of (i) or (ii).

In an embodiment of the third aspect, the first schema has a first quantity of data fields, the second schema has a second quantity of data fields, and the first quantity is different from the second quantity.

In an embodiment of the third aspect, the first information storage system comprises a plurality of redundant, geographically-distributed data storage systems.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. An integrated electronic information system comprising:
a first information storage system accessible to users through a first communications channel, the first information storage storing information in a first form;
a second information storage system accessible to users through a second communications channel, the second information storage storing information in a second form that is different from the first form; and
an electronic integration system, in electronic communication with the first information storage system and the second information storage system, configured to:
receive an indication from the first information storage system of data that is newly-added to the first information storage system;
receive the data from the first information storage system in the first form; and
in response to the indication from the first information storage system:
translate the data from the first form to the second form; and
transmit the data in the second form to the second information storage system.

2. The integrated electronic information system of claim 1, wherein the first information storage system is configured to transmit the indication to the integration system automatically upon receipt of the data.

3. The integrated electronic information system of claim 1, wherein the data is first data respective of a transaction, wherein the integration system is further configured to:
receive a second indication from the second information storage system of second data that is newly-added to the second information storage system, the second data respective of the transaction;
receive the second data from the second information storage system; and
in response to the second indication from the second information storage system:
translate the second data from the second form to the first form; and
transmit the second data in the first form to the first information storage system.

4. The integrated electronic information system of claim 3, wherein the second information storage system is configured to transmit the second indication to the integration system automatically upon receipt of the second data.

5. The integrated electronic information system of claim 1, wherein the first communications channel is one of (i) an on-premises user interface or (ii) a website or mobile application, and the second communications channel is the other of (i) or (ii).

6. The integrated electronic information system of claim 1, wherein the first form comprises a first schema and the second form comprises a second schema, wherein the first schema is different from the second schema.

7. The integrated electronic information system of claim 1, wherein the second information storage system is configured to:
receive the data in the second form from the integration system;
determine that the data is associated with a transaction having a record in the second information storage system; and
update the record according to the data.

8. The integrated electronic information system of claim 1, wherein the second information storage system is configured to:
receive the data in the second form from the integration system;
determine that the data is associated with a transaction that does not have a record in the second information storage system; and
create a record in the second information storage system for the transaction, the record comprising the data.

9. A method comprising:
receiving, by an electronic data storage integration system from a first information storage system, an indication of data that is newly-added to the first information storage system, wherein the first information storage system is user-accessible through a first interface;
receiving, by the electronic data storage integration system from the first information storage system, the data in a first schema;
translating, by the electronic data storage integration system, the data from the first schema to a second schema; and
transmitting, by the electronic data storage integration system, the data in the second schema to a second information storage system, wherein the second information storage system is user-accessible through a second interface.

10. The method of claim 9, further comprising:
automatically transmitting, by the first information storage system, the indication to the integration system automatically upon receipt of the data.

11. The method of claim 9, wherein the data is first data respective of a transaction, the method further comprising:
receiving, by the electronic data storage integration system, a second indication from the second information storage system of second data that is newly-added to the second information storage system, the second data respective of the transaction;
receiving, by the electronic data storage integration system, the second data from the second information storage system in the second schema; and
by the electronic data storage integration system, in response to the second indication from the second information storage system:
translating the second data from the second schema to the first schema; and
transmitting the second data in the first schema to the first information storage system.

12. The method of claim 11, further comprising:
transmitting, by the second information storage system, the second indication to the integration system automatically upon receipt of the second data.

13. The method of claim 9, wherein the first interface is one of (i) an on-premises user interface or (ii) a website or mobile application, and the second interface is the other of (i) or (ii).

14. The method of claim 9, further comprising:
receiving, by the second information storage system, the data in the second schema from the integration system;
determining, by the second information storage system, that the data is associated with a transaction having a record in the second information storage system; and
updating, by the second information storage system, the record according to the data.

15. The method of claim 9, further comprising:
receiving, by the second information storage system, the data in the second schema from the integration system;
determining, by the second information storage system, that the data is associated with a transaction that does not have a record in the second information storage system; and
creating, by the second information storage system, a record in the second information storage system for the transaction, the record comprising the data.

16. An integrated electronic information system comprising:
a first information storage system accessible to users through a first interface, the first information storage storing information in a first schema;
a second information storage system accessible to users through a second interface, the second information storage storing information in a second schema; and
an electronic integration system, in electronic communication with the first information storage system and the second information storage system, configured to automatically translate data added to the first information storage system from the first schema to the second schema and to automatically translate data added to the second information storage system from the second schema to the first schema to create duplicate records in the first and second information storage systems.

17. The integrated electronic information system of claim 16, wherein the electronic integration system is further configured to automatically transmit data translated to the second schema to the second information storage system and to automatically transmit data translated to the first schema to the first information storage system.

18. The integrated electronic information system of claim 16, wherein the first interface is one of (i) an on-premises user interface or (ii) a website or mobile application, and the second interface is the other of (i) or (ii).

19. The integrated electronic information system of claim 16, wherein the first schema has a first quantity of data fields, the second schema has a second quantity of data fields, and the first quantity is different from the second quantity.

20. The integrated electronic information system of claim 16, wherein the first information storage system comprises a plurality of redundant, geographically-distributed data storage systems.
